(19) United States
(12) Patent Application Publication
(10) Pub. No.: US 2011/0015816 A1
(43) Pub. Date: Jan. 20, 2011

(54) Aviation ground navigation system

(75) Inventors: John H. Dow, Auburn, NY (US); Terry Summerson, Currituck, NC (US); William Hunt, Johnstown, PA (US)

Correspondence Address: RADER FISHMAN & GRAUER PLLC, LION BUILDING, 1233 20TH STREET N.W., SUITE 501, WASHINGTON, DC, 20036, US

(73) Assignee: MOUNTAINTOP TECHNOLOGIES, INC., Johnstown, PA (US)

(21) Appl. No.: 12/461,259

(22) Filed: Aug. 5, 2009

Related U.S. Application Data
(63) Continuation of application No. 12/320,172, filed on Jan. 21, 2009, now abandoned.
Application No. 12/320,172 is a continuation of application No. 12/155,968, filed on Jun. 12, 2008, now abandoned.
(60) Provisional application No. 60/929,183, filed on Jun. 15, 2007.

(51) Int. Cl. G08G 5/06

(52) U.S. Cl. 701/23

(57) ABSTRACT

Transporting aircraft within an airport operational area. An airport operational area within which an unmanned ground vehicle is configured to selectively tow aircraft is defined. A ground tracking system provides position data signals to determine the position of the unmanned ground vehicle position relative to positions in at least one operational area path contained in the airport operational area. This positioning is supplemented by the position as determined from an electronic tracking system, such as a radar-based system. The unmanned ground vehicle is then selectively guided to engage and tow the aircraft to a selected position within the airport operational area.

### CROSS REFERENCE TO RELATED APPLICATIONS

The present application is a Continuation Application of the Parent application Ser. No. 12/320,172, filed Jan. 21, 2009, which is a Continuation of application Ser. No. 12/155,968, filed Jun. 12, 2008, which in turn claims priority to U.S. Provisional Application Ser. No. 60/929,183, entitled “Aviation Ground Navigation System,” filed on Jun. 15, 2007, the entire contents of which are hereby incorporated by reference.

### STATEMENT REGARDING FEDERALLY SPONSORED RESEARCH AND DEVELOPMENT

Research and development for this invention was sponsored by the Office of Naval Research, under Contract Award No. N00014-05-C-0055.

### BACKGROUND OF THE INVENTION

1. Field of the Invention

This invention pertains to a system for navigating aircraft on the ground. More specifically, it pertains to a system for safely, securely, and efficiently navigating aircraft on the ground using a semi-autonomous unmanned ground vehicle in conjunction with asset tracking radar, communication technology, and a control center.

2. Description of the Related Art

Traditionally, aircraft have been moved on a runway or taxiway using the power of their own jet engines. However, the use of jet engines on the ground is highly inefficient in terms of fuel use and harmful pollutant emissions. Additionally, aircraft movement activities on the ground often lead to injury or death due to mishandling of the aircraft on the ground.

Accordingly, it is desirable to find a less dangerous and more efficient means of transporting and navigating aircraft on the ground.

U.S. Pat. No. 6,600,992, entitled “Airport Ground Navigation System” and commonly assigned herewith, discloses an example of an airport ground navigation system that uses aircraft tugs and a system for centralized positive control of aircraft movements.

A method, apparatus and system with improved efficiency, accuracy and aircraft engagement techniques is desirable.

### SUMMARY OF THE INVENTION

The present invention provides a system which enhances aviation operations by centralizing and synthesizing airline movement activities while improving safety, security, and efficiency. The present invention provides additional benefits by reducing runway incursions, enhancing asset management, reducing fuel consumption, reducing emissions, reducing engine cycle/component time, and increasing overall airline ground efficiency.

The Aviation Ground Navigation System (AGNAS) is an integrated system comprising unmanned ground vehicles (UGVs), asset tracking radar for collision avoidance, communications technology, and a control center. AGNAS utilizes the control center which interfaces between semi-autonomous movement of UGVs and asset tracking radar for collision avoidance.

AGNAS is a system utilizing an open operating system offering a real-time visual data-monitoring platform against an airbase static display. The system controls a semi-autonomous vehicle through a wireless semi-autonomous network communication backbone. The network hosts data information sources that will be accessed in the Remote Control Center (RCC) platform. The RCC centralizes and synthesizes aviation operations through Semi-Autonomous Ground Vehicle Control (selected vehicles), Situational Awareness (asset visibility in operating area), and Communications (multi-band communications between various systems and frequency ranges).

### BRIEF DESCRIPTION OF THE DRAWINGS

These and other more detailed and specific features of the present invention are more fully disclosed in the following specification, reference being had to the accompanying drawings, in which:

FIG. 1 is a block diagram illustrating an example of an aviation ground navigation system according to one embodiment of the present invention.

FIG. 2 is a block diagram illustrating an example of the UGV Subsystem.

FIG. 3 is a block diagram of a command and control module.

FIG. 4A is a display diagram illustrating an example of defining an airport operational area comprising one or more operational area paths.

FIG. 4B is a display diagram illustrating an example of flexible navigation in confronting an obstacle in mission pathing.

FIG. 4C is a display diagram illustrating an example of aircraft docking.

FIG. 4D is a display diagram illustrating such a data fusion of radar and GPS data.

FIG. 5 is a flow diagram illustrating a method for transporting aircraft within an airport operational area.

### DETAILED DESCRIPTION OF THE INVENTION

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically illustrated or described in detail to avoid obscuring aspects of embodiments of the present invention.

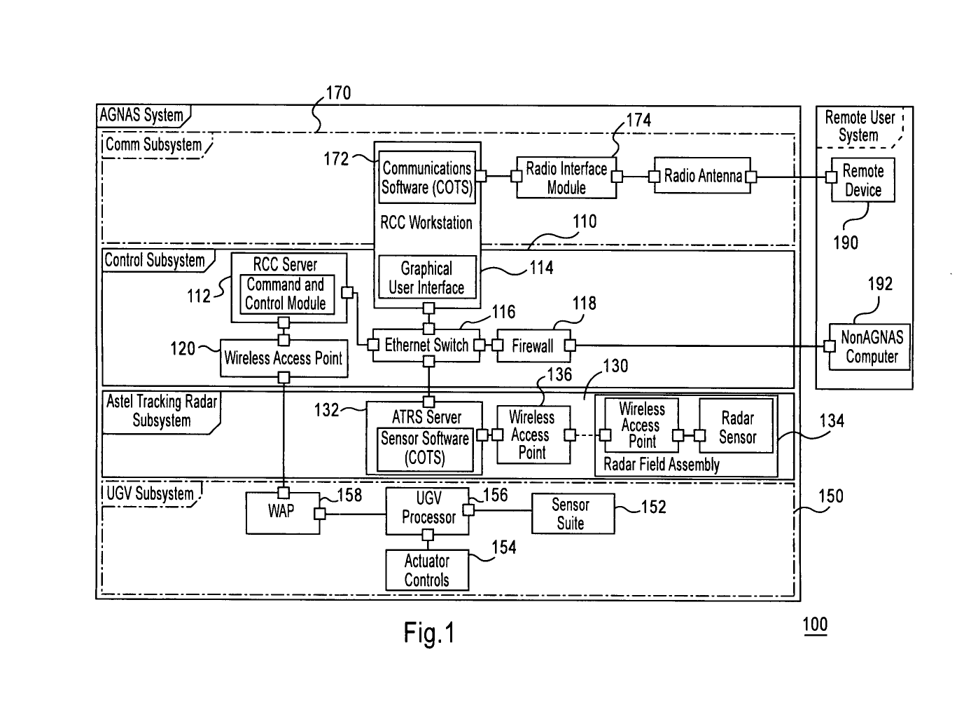

FIG. 1 is a block diagram illustrating an example of an aviation ground navigation system (AGNAS) 100. AGNAS 100 can be subdivided into four subsystems, identified as Control 110, Asset Tracking Radar 120, UGV 130, and Communication 140.

The Control subsystem 110 consists of an Remote Control Center (RCC) server 112, RCC workstation 114, and handheld devices to provide the core functionality of AGNAS. The RCC server 112 collects, translates, evaluates, stores, and fuses real-time asset data to control unmanned ground vehicles (UGVs) and to provide situational awareness for semi-autonomous functionality. The Graphical User Interface (GUI) graphically displays all assets on the designated operational area and allows control of the UGVs. The control subsystem 110 also includes the wireless hardware needed to establish a wireless local area network (WLAN) over the operational area.

The Asset Tracking Radar Subsystem (ATRS) 130 collects positional data on aircraft, vehicles, people, and obstacles. This provides the RCC and UGV obstacle data, including that outside the UGV's on-board sensor range.

The UGV subsystem 150 simulates a docking maneuver with an aircraft or other identified mobile Ground Support Equipment (GSE)/Maintenance Support Equipment (MSE) that may be towed on the operational area. The on-board navigation component, coupled with direction from the RCC, GPS information, and obstacle data from the onboard sensor suite and the ATRS, gives the vehicle the local coordinate path needed for it to travel safely. The UGV is able to operate in three modes: manual, remote control, and semi-autonomous.

The Communications subsystem 170 provides continuous voice communications in a seamless manner among all key personnel, regardless of their existing radio communications systems. This capability may, for example, be provided through a multi-band communications management system.

Modes of Operation. AGNAS is defined as having three modes of operation that are identified as follows: 1) Manual, 2) Remote Control (also known as Tele-operated), and 3) Semi-Autonomous. These three modes of operation are further defined with respect to the control of an UGV and associated processes necessary to ensure safe and efficient operations. Further details relevant to each mode of operation are provided in the following paragraphs.

The Manual mode of operation entails the typical control of the UGV by a vehicle driver using standard equipped manual vehicle controls without any intervention by AGNAS. The UGV actuators, supporting semi-autonomous and remote control, are deactivated in this mode. However, the UGV sensor suite is energized to provide continuous vehicle status and position data.

The Remote Control (Tele-operated) mode of operation enables the RCC Operator or Airbase Ramp Manager to remotely control the UGV movement through the RCC graphical user interface (GUI) provided on the RCC workstation. Key personnel working in the UGV operating area may also initiate an “Emergency Stop” if necessary by pushing one of the several manual “Emergency Stop” buttons located on the UGV. Once the “Emergency Stop” button is initiated, the vehicle will be in an “Emergency Stop” state and default to manual mode. Capabilities also include the implementation of the remote control feature from an AGNAS handheld device/Personal Digital Assistant (PDA).

The Semi-Autonomous mode of operation enables the RCC Operator to execute a mission plan with minimal to no intervention from the RCC Operator. The UGV semi-autonomously traverses the route according to the mission plan. In doing so, if the onboard UGV vision sensors detect an obstacle in the path of the UGV, the UGV automatically selects an evasive maneuver to avoid the obstacle and then continues on its original route. If the ATRS sensor detects an obstacle outside the range of the UGV vision sensors, the RCC may command the UGV to alter its course. If additional conflicts exist with any of the evasive maneuvers, the UGV stops and waits for RCC Operator instructions. The RCC Operator then safely maneuvers the UGV via remote control.

Should key personnel working in the UGV operating area foresee an unsafe condition while the UGV is operational in semi-autonomous mode, they have the ability to initiate the Emergency Stop as previously described. Again, once the Emergency Stop button is initiated, the vehicle will be in an Emergency Stop state and default to manual mode.

Operation Sequences. The AGNAS control flow begins with the initialization of the AGNAS system 100. Upon completion of the initialization activity, the specific mode of operation and system configuration details are input by the RCC Operator.

Following system initialization, the next logical event is the planning and scheduling of the UGV route. At the time of execution, the UGV's path is determined and continuously monitored for obstacles. If an obstacle is detected in the path of the UGV, then the current path is modified to avoid the obstacle and the UGV continues to its original destination.

Following planning of the UGV route, the next step in the control flow is the operation of the UGV. The operation activity requires input from previous activities prior to execution. This activity is embedded with an emergency override feature that will stop the UGV in the event of an obstacle in the UGV route.

Still referring to FIG. 1, Control subsystem 110 includes an RCC Server 112, RCC Workstation 114, Ethernet Switch 116, Firewall 118, Wireless Access Point 120, and Handheld Devices/(PDA).

The RCC Server 112 provides command and control functionality through behavioral, data fusion, and mission planning components. These components are preferably provided as software that provides the functionality described herein when such software is executed by a computer. These components integrate the existing systems and provide positive control over the UGV and provide the RCC operator a depiction of the operational area. The RCC Server 112 has the capacity to perform data fusion requiring multi-pass calculations in real-time and a fault-tolerant system for data integrity.

The RCC workstation 114 is preferably based on a standard workstation configuration. The RCC Workstation 114 provides the RCC graphical user interface (GUI). The RCC GUI allows the RCC Operator to monitor all UGV movements and asset information in real-time. Additionally, the RCC GUI can interact with each subsystem to monitor the status and possibly modify the functionality of certain subsystems. For example, the operator may choose to operate an UGV via remote control or may choose to command an UGV to execute a stored mission. The RCC Workstation has the capability to display the positional data and graphical data tags in real-time for all assets and signals tracked by AGNAS. The maps are preferably scale-to-zoom or change sector with minimal lag, and transparent data layers may be added and removed without compromising the graphical display's refresh rate.

The Ethernet switch 116 connects the hardware components by forming a local area network. In particular, the Ethernet switch 116 connects the RCC Server 112, RCC Workstation 114, Firewall 118, and ATRS server 132.

A properly configured firewall 118 prevents malicious network traffic from entering and potentially disrupting the local environment. The firewall 118 in the AGNAS system 100 protects the AGNAS system from intrusion or data corruption from offsite users and validates a remote control center's portability in a real networking setting. The firewall 118 protects the AGNAS network from unauthorized access by providing security and an upgradeable Virtual Private Network (VPN) endpoint.

The Wireless Access Point (WAP) 120 allows for mobile communications between the RCC Server 112, UGV 150, ATRS 130, and Remote Device(s) 190 (e.g., Personal Digital Assistants (PDA)). Wireless communication between these hardware components greatly enhances the overall functionality of AGNAS and increases safety by allowing multiple key personnel to monitor and control AGNAS subsystems via a PDA. The Wireless Access Point preferably provides connectivity over the entire operational area governed by the AGNAS system 100.

An exemplary Remote Device 190 grants a subset of the RCC Workstation 114 functionality to its user. It is preferably Wi-Fi enabled, giving its user the means to make operational decisions involving the UGV and airbase facility. Each Remote Device 190 has a mini-GUI which acts as an interface to both the RCC Workstation 114 and the RCC Server 112.

Asset Tracking Radar Subsystem. The Asset Tracking Radar Subsystem (ATRS) 130 collects positional data on aircraft, vehicles, people, and obstacles. This provides the RCC with asset information allowing a UGV path to be monitored for obstacles beyond its onboard vision sensor ranges. The ATRS 130 is used to monitor the operational area on a continuous basis in all types of weather conditions. The ATRS 130 includes the ATRS Processor (Server) 132, Radar Field Sensor 134, and a Wireless Access Point 136, as well as a Power Converter and Systems Integration Unit (SIU).

The ATRS 130 has the ability to automatically track and send precise positions of multiple targets through a wired connection or optionally a wireless connection through a wireless access point. The target data streams, which represent fixed and moving targets, are displayed on the RCC GUI. This constant vigilance offered by the ATRS gives target dimensions, location, speed, direction, and pending collision alerts.

The ATRS 130 provides increased safety and capacity cost effectively, eliminates blind spots, improves accuracy, and enhances existing surveillance systems. The ATRS 130 is preferably capable of providing 360° azimuth coverage with an angular adjustment range in respect to the mounting plane. The field sensor 134 is preferably a rugged field sensor capable of withstanding harsh outdoor environments with no scan degradation.

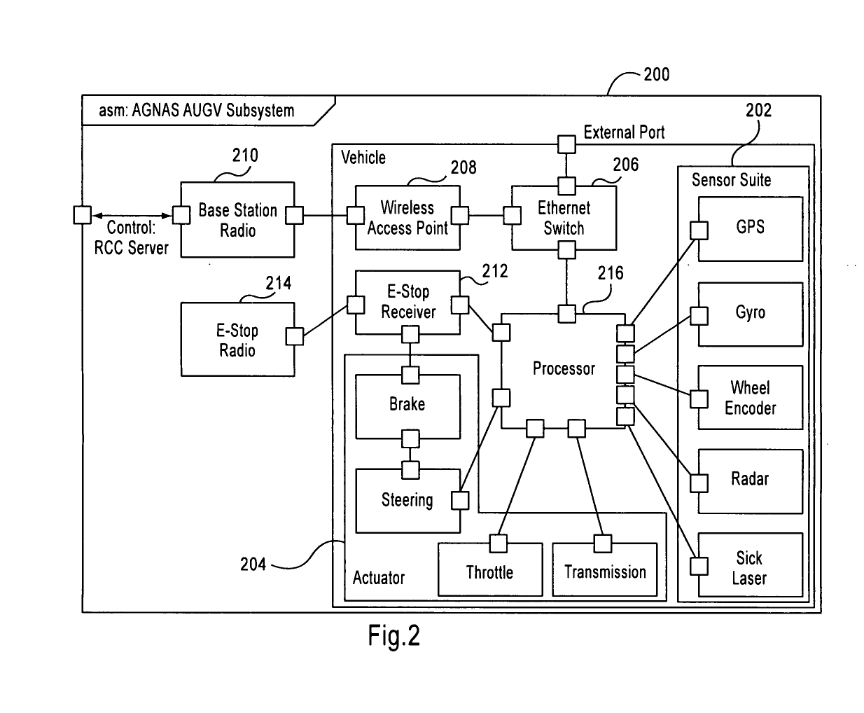

UGV Subsystem. The UGV subsystem 150 employs a sensor suite 152 for collision avoidance and object recognition. It also includes actuator controls 154, a wireless access point 158 and processor 156 that executes software for coordinating the functions of the various modules and providing the functionality described herein. Additional features of the UGV subsystem 150 are described in connection with FIG. 2 below. The UGV is capable of operating in manual, remote control, or semi-autonomous mode. The UGV subsystem 150 preferably meets Joint Architecture for Unmanned Systems (JAUS) compliance.

The UGV subsystem 150 provides instructions that facilitate remote guidance of the UGV over an operating area, emulates the airbase environment, maintain continuous communication with the RCC, and prompt the UGV to respond to and avoid obstacles in a safe and timely manner. As described further below, the UGV will preferably operate in a closed operational area that can be variously defined depending upon the particulars of the airport in which the AGNAS system operates.

The UGV subsystem 150 maintains the following core functionalities. 1) Remote guidance may take the form of remote control or semi-autonomous navigation based on waypoint instruction. The vehicle should also be capable of local override, i.e. manual operation. 2) A common airbase environment is a paved, level surface that may be mapped into the UGV with defined areas of operation. Airbase static obstacles are known upon completion of each site survey. Mobile objects are fully anticipated and incorporated into the AGNAS design. 3) Continuous communication, such as via an 802.11 wireless standard. 4) The UGV is able to detect obstacles within its immediate path. The immediate path is defined as the area of probable travel in front of the robotic vehicle and to each side, extending forward to at least the braking distance of the vehicle. Obstacles are defined as any objects that have the potential to interrupt the movement of the UGV.

The UGV is preferably a robotic, electric vehicle with an actuation system granting computer control of the steering, throttle, brakes, and gearshift. The UGV system preferably allows for semi-autonomous control, remote control, or manual override of the UGV. Further, the UGV is preferably capable of identifying obstacles in its immediate path.

One example of an UGV suitable for use in the present invention is the JETporter Jp100S Towbarless Aircraft Tow Tractor, produced by Tronair and modified by MountainTop Technologies for unmanned control. The Jp100S will be a JAUS (Joint Architecture for Unmanned Systems) compliant vehicle that can be remotely controlled through an Operator Control Unit, which is a GUI for the user. The UGV is also preferably capable of semi-autonomous control via the onboard Obstacle Detection and Obstacle Avoidance (ODOA) software. There are several vision sensors on the front of the Jp100S. The first is the SICK Laser Range Finder, which accurately detects obstacles within 30 to 40 meters. If an obstacle is detected in the immediate path of the Jp100S, it attempts to either dodge the obstacle, or stop and wait for assistance from the Operator Control Unit.

The Jp100S is designed to be a ruggedized vehicle. Not only is the vehicle weather tight, but all onboard data is stored on flash drives, which unlike conventional hard disk drives, do not crash under heavy vibration. Also, the vehicle operates with a jPower power supply. This regulates the battery power outputted to each hardware component, ensuring that the voltage does not drop or spike, causing damage to sensitive equipment. If the voltage were to change, the Operator Control Unit would be notified.

FIG. 2 is a block diagram illustrating an example of the UGV Subsystem 200 in further detail. The UGV Subsystem 200 includes a sensor suite module 202 that communicates with the various sensors used by the UGV including the denoted GPS, Gyro, Wheel Encoder, and Sick Laser sensors that are described herein. The UGV subsystem 200 also includes an actuator module 204 that variously manages the actuation of the UGV such as via the denoted brake, steering, throttle, and transmission components. Also included are an Ethernet port 206, a wireless access point 208, and corresponding communication with a base station radio 210 for facilitating the previously introduced network communications, including wireless, with the other components. An E-Stop receiver 212 accommodates emergency stopping of the UGV such as that based upon an emergency stop command received from the E-stop radio 214. The various UGV components are preferably software that is executed by the processor 216 to provide the described functionality. Alternatively they may be hardware, firmware, or any combination of software, hardware and firmware.

Communication Subsystem. Still referring to FIG. 1, the Communication subsystem 170 is capable of providing continuous voice communications between the RCC and key personnel. The intent of the voice communications design is to eliminate the need for several stand-alone systems that lack interoperability.

The Communication subsystem 170 includes the RCC Software Interface 172, Static Radio 174, Wireless Network Backbone (Radio over Internet Protocol), and the corresponding Remote Devices 190.

The Communication subsystem 170 is flexible and scalable to meet the user interface requirements. It has the ability to communicate to a radio located on the UGV, a static radio system, and key personnel at the airbase locations. The communication subsystem 170 has accessibility through the RCC, Remote Device 190, Ramp Personnel, and remote terminals. All user interfaces preferably have security key identification access through recognized accounts.

The Communication subsystem 170 preferably implements software configured to provide the ability to monitor the radio software interface and perform the same functionality as a stand-alone radio system. The software enables the RCC Operator to visually monitor and select the radio system that is currently hailing and return confirmation by voice back to the same party. The Communication subsystem 170 has the ability to talk to the same radio system that enabled the call sequence and additionally to talk to virtually any radio that enters the area network via the communication subsystem radio modules. The ability to patch landline phones to radio or satellite connections, as well as Internet phones, can exist.

Although a variety of technologies and architectures may be provided, examples include commonly known industry technologies for Inter-process Communications (IPQ), Reusable classes (a benefit of Object Oriented Design) and other items to provide flexibility to the system.

AGNAS System 100 may also use the Berkeley Software Distribution (BSD) socket interface for TCP/IP programming. The socket IPC facilities were designed to allow network-based programs to be constructed independently of the underlying communications facilities. The AGNAS system 100 may use sockets over TCP/EP for communication between the RCC workstation, server, and ATRS subsystem. For the AGNAS User Datagram Protocol (UDP) may be used to communicate with the UGV. Processes running on the same processor may also be multi-threaded and use shared memory.

The Command and Control Module (CCM) of the RCC server 112 incorporates processes and stores data from the Unmanned Ground Vehicle (UGV), Asset Tracking Radar Subsystem (ATRS), and the Remote Control Center (RCC) Graphic User Interface (GUI). The CCM and AGNAS Database reside on the RCC server.

In one example, the CCM may be configured as follows. 1) The CCM has the capability to create a Virtual Map as a C++ data structure and is able to store/retrieve it from the database. The Virtual Map is a digital representation of the operational area in a static state. More technically, the Virtual Map is a grid of the operational area with cells that have levels of accessibility for UGV navigation. 2) Given input from ATRS, UGVs, and the database, the CCM generates an accurate Depiction, a snap shot of the targets on a live operational area, as a C++ data structure and the CCM is able to store/retrieve it from the database. Targets are not only UGVs, but also stationary and moving non-AUGV targets (e.g. fallen luggage, a moving fire, truck). 3) The CCM mitigates discrepancies between the UGV GPS data and the ATRS data with respect to the location of an UGV. 4) The CCM maintains a dynamic version of the initial Virtual Map (VM). 5) Using VM and behavioral rules, the CCM determines if an UGV mishap may occur. If so, the CCM instructs the UGV to take evasive action(s). 6) The CCM has the capability to process UGV command and control requests from the RCC GUI. 7) The CCM has the capability to process ATRS control requests from the RCC GUI. 8) The CCM has the capability to create, update, and delete mission plans from the AGNAS database. 9) The CCM has the capability to request the execution of mission plans. 10) The CCM manages mission plans in a variety of scenarios. 11) The CCM creates and maintains necessary TCP/EP socket connections. 12) Using ODBC, the CCM creates and re-uses the same database connection per AGNAS process, and uses ODBC/SQL database requests. 13) The CCM models and creates a relational database to store required AGNAS persistent data.

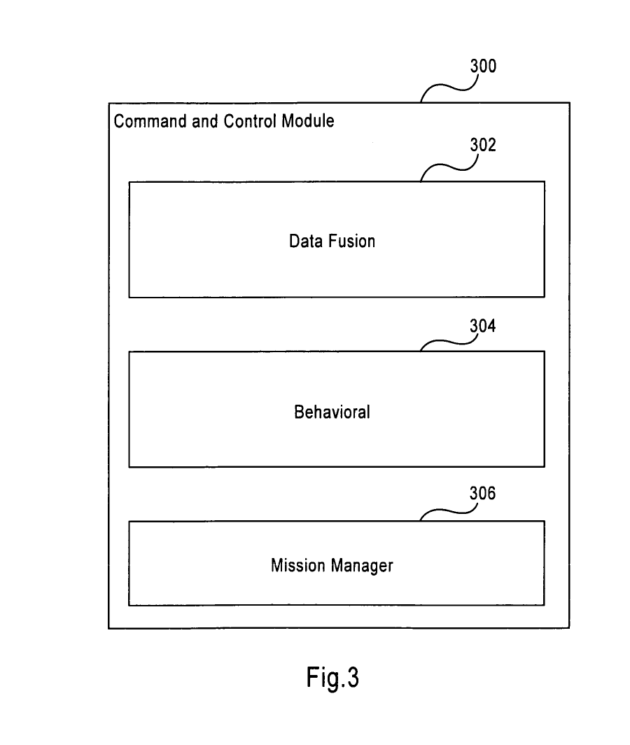

FIG. 3 is a block diagram of the CCM 300 in further detail. The CCM is a combination of three subcomponents, namely Data Fusion 302, Behavioral 304, and Mission Manager 306. The CCM 300 is preferably software that is executed by a processor to provide the described functionality. Alternatively the CCM 300 may be composed of hardware, firmware, or any combination of software, hardware or firmware.

Data Fusion 302 can be thought of as the eyes of the CCM. It is responsible for continuously repeating the following action: receiving and fusing input data from the ATRS and UGV by constructing a depiction of the target(s) on the operational area and then updating Virtual Map.

The Behavioral sub-component 306 can be thought of as the brain of the CCM. Its primary duty is to instruct the UGV of where to go and what to do and, most importantly, to prevent the UGV from having a mishap while trying to complete a mission. It accomplishes this by plotting the safest, most efficient path to the user defined destination point by generating intermediate waypoints in real-time based upon the state of the Virtual Map at that time. Unlike the user defined destination point, it is possible that the system generated, intermediate waypoints may never be reached since they are constantly changing with regard to the state of the Virtual Map. A user defined destination point must be reached to successfully complete a mission. A mishap is a collision with a stationary or moving target or traversing to an out of bounds sector.

The Mission Manager 308 has the responsibility to make sure UGV mission plans that overlap execution times are scheduled as optimally as possible.

AGNAS Database Software. Persistent data from the AGNAS system 100 is stored in a database. The AGNAS Database has the following capabilities. 1) The database chronologically stores the operational area's activities. This data is queried when the RCC Operator requests playback of the operational area's recent activities. 2) The database stores information regarding predefined UGV missions. These missions are broken up and stored as individual steps. 3) The database is responsible for storing predefined rules for UGV operating environments. These rules allow the UGV to respond correctly to a multitude of operating conditions. 4) The database stores login information for each RCC Operator for security purposes. 5) The database stores information pertaining to the general operation of AGNAS.

Although the database may be physically stored in one database file on the RCC Server, it may further be designed with a logical separation of the major sections: 1) Historical, 2) Mission, and 3) Rules.

The Historical subdivision is responsible for storing the operational area's activities as compiled by the Data Fusion component of the CCM. Furthermore, the Historical subdivision is designed to have fused data inserted approximately every second. Fused data consists of data sent from the ATRS that is compared with data received from the UGV. The Data Fusion component of the CCM creates the fused data for an accurate depiction of targets on the operational area.

The Mission subdivision of the AGNAS database is designed to allow the RCC Operator to create new missions and update or delete existing missions. User-defined missions consist of a series of steps, where each step is defined by a set of destination coordinates. The destination coordinates refer to an RCC Operator-defined Virtual Map stored within the database. The Virtual Map is represented as a set of coordinates and values. The collection of values from the Virtual Map represent all the defined pathways and all the out-of-bounds sectors for the UGVs. During normal operation, only one Virtual Map is needed. However, while testing the system, several varied Virtual Maps can be used one at a time to see how the UGV reacts under certain conditions. The RCC Operator has the ability to create and store multiple Virtual Maps. A new Virtual Map can reflect a permanent or semi-permanent change in the operational area. For instance, if a construction area were created, a Virtual Map could be defined to reflect those changes and notify the CCM of path changes. Once construction stopped, the original Virtual Map could be used.

The design of the Rules subdivision is structured in a way that allows the RCC Operator to add, remove, or update existing rules. These rules define the UGV's operating parameters for each stored situation. For example, when visibility is minimal, the UGV would follow the corresponding rule that would likely change the UGV's operating parameters. The headlights would be turned on, and the maximum travel speed for the UGV would be reduced. This subsection has the ability to expand or contract, depending on the type of rules and situations that are discovered.

Mission Plans are created and stored by the RCC GUI in the AGNAS database with unique missionIds. Upon request for execution, the RCC GUI sends the missionId to the CCM. The CCM then retrieves the mission plan from the database for execution.

The database is designed with data integrity in mind. The term data integrity refers to the ability to query, update, or delete rows from the database without producing unwanted anomalies. To achieve database integrity, all tables are normalized to at least Third Normal Form (3NF). The AGNAS Database Model components are described in the AGNAS Data Dictionary below.

AGNAS Software Data Dictionary: The AGNAS Software Data Dictionary comprises A) Tables and B) Attributes incorporated in the Tables.

A) Tables:

Table Name: UGV. UGV is a table in the AGNAS database. It is intended to store information regarding individual UGVs, both in and out of operation.

Table Name: FUSED_DEPICTION. FUSED_DEPICTION is a table in the AGNAS database. It is intended to store data received from the Data Fusion component of the CCM. It is a depiction of the ATRS information fused with data from the UGV.

Table Name: MISSION. MISSION is a table in the AGNAS database. It is intended to store information pertaining to UGV missions.

Table Name: SITUATION. SITUATION is a table in the AGNAS database. It is intended to store rules governing the safe operation of each UGV.

Table Name: STEP. STEP is a table in the AGNAS database. It is intended to store information pertaining to UGV missions, specifically each step of a mission.

Table Name: USER. USER is a table of the AGNAS database. It stores login information related to the RCC Operators.

Table Name: VIRTUAL_MAP. VIRTUAL_MAP is a table in the AGNAS database. It is intended to store information pertaining individual Virtual Maps of the operational area.

Table Name: VIRTUAL_MAP_COORD. VIRTUAL_MAP_COORD is a table in the AGNAS database. It is intended to store detailed information pertaining to individual Virtual Maps used during testing.

B) Attributes:

Attribute Name: abort. Type: SITUATION Attribute. Definition: abort is an attribute of the SITUATION table of the AGNAS database. It determines if the UGV, under a defined situation, should completely abort its current mission and return to its Home. Data Type: Boolean.

Attribute Name: ugvHomeLat. Type: UGV Attribute. Definition: ugvHomeLat is an attribute of the UGV table of the AGNAS database. It defines the latitude coordinate associated with an UGV's Home. Data Type: Float.

Attribute Name: ugvHomeLong. Type: UGV Attribute. Definition: ugvHomeLong is an attribute of the UGV table of the AGNAS database. It defines the longitude coordinate associated with an UGV's Home. Data Type: Float.

Attribute Name: ugvID. Type: UGV Attribute. Definition: ugvId is an attribute of the UGV table of the AGNAS database. It contains the ID of the UGV responsible for the entry into the database. Data Type: Integer.

Attribute Name: ugvName. Type: UGV Attribute. Definition: ugvName is an attribute of the UGV table of the AGNAS database. It contains the name of the UGV responsible for the entry into the database. Data Type: String.

Attribute Name: course. Type: FUSED_DEPICTION Attribute. Definition: course is an attribute of FUSED_DEPICTION table of the AGNAS database. This attribute contains the course direction of the targeted item. Data Type: Float.

Attribute Name: destLatitude. Type: STEP Attribute. Definition: destLatitude is an attribute of the STEP table of the AGNAS database. It contains the latitudinal coordinate of the UGV's destination waypoint. Data Type: Float.

Attribute Name: destLongitude. Type: STEP Attribute. Definition: destLongitude is an attribute of the STEP table of the AGNAS database. It contains the longitudinal coordinate of the UGV's destination waypoint. Data Type: Float.

Attribute Name: detect. Type: Attribute. Definition: detect is an attribute of FUSED_DEPICTION table of the AGNAS database. It represents if the target is still being detected. Data Type: Integer.

Attribute Name: duration. Type: MISSION Attribute. Definition: duration is an attribute of the MISSION table of the AGNAS database. It contains the number of minutes a particular mission is scheduled to last. This information is used during UGV scheduling. It is stored as a number of expected minutes. Data Type: Integer.

Attribute Name: hazardLevel. Type: VIRTUAL_MAP_COORD Attribute. Definition: hazardLevel is an attribute of the VIRTUAL_MAP_COORD table of the AGNAS database. It represents if the UGV ability or inability to traverse through a particular grid on the Virtual Map. A zero indicates out of bounds, one indicates the best path, and numbers greater than one indicate increasingly poor pathways. Data Type: Integer.

Attribute Name: latitude. Type: FUSED_DEPICTION Attribute. Definition: Latitude is an attribute of the FUSED_DEPICTION table of the AGNAS database. It contains the latitude coordinate of a target reported from the ATRS and UGV GPS data. Data Type: Float.

Attribute Name: length. Type: FUSED_{—} DEPICTION Attribute. Definition: length is an attribute of the FUSED_DEPICTION table of the AGNAS database. It contains the length of the target either as sent by the UGV or received by the ATRS. Data Type: Integer.

Attribute Name: longitude. Type: FUSED_DEPICTION Attribute. Definition: Longitude is an attribute of the FUSED_DEPICTION table of the AGNAS database. It contains the longitude coordinate of a target reported from the ATRS or UGV. Data Type: Float.

Attribute Name: mapHeight. Type: VIRTUAL_MAP Attribute. Definition: mapHeight is an attribute of the VIRTUAL_MAP table of the AGNAS database. It contains the height of the background image in pixels. Data Type: Integer.

Attribute Name: mapId. Type: VIRTUAL_MAP Attribute. Definition: mapId is an attribute of the VIRTUAL_MAP table of the AGNAS database. It contains a unique identifier for each stored Virtual Map. Data Type: Integer.

Attribute Name: mapName. Type: VIRTUAL_MAP Attribute. Definition: mapName is an attribute of the VIRTUAL_MAP table of the AGNAS database. It contains a name description of the stored Virtual Map. Data Type: String.

Attribute Name: mapPath. Type: VIRTUAL_MAP Attribute. Definition: mapPath is an attribute of the VIRTUAL_MAP table of the AGNAS database. It contains a filename path to a supported background image to be displayed on the RCC GUI. Data Type: String.

Attribute Name: mapWidth. Type: VIRTUAL_MAP Attribute. Definition: mapWidth is an attribute of the VIRTUAL_MAP table of the AGNAS database. It contains the width of the background image in pixels. Data Type: Integer.

Attribute Name: missionId. Type: MISSION Attribute. Definition: missionId is an attribute of the MISSION table of the AGNAS database. It contains a unique identifier for each stored mission. Data Type: Integer.

Attribute Name: missionName. Type: MISSION Attribute. Definition: missionName is an attribute of the MISSION table of the AGNAS database. It contains the name of the mission. Data Type: String.

Attribute Name: scheduled. Type: MISSION Attribute. Definition: scheduled is an attribute of the MISSION table of the AGNAS database. It reveals if a particular mission has been scheduled to start. Data Type: Boolean.

Attribute Name: situationDesc. Type: SITUATION Attribute. Definition: situationDesc is an attribute of the SITUATION table of the AGNAS database. It contains a brief description of the situation that may affect operations of the UGV. Data Type: String.

Attribute Name: situationId. Type: SITUATION Attribute. Definition: situationId is an attribute of the SITUATION table of the AGNAS database. It contains a unique identifier for each situation stored in the database. Data Type: Integer.

Attribute Name: situationName. Type: SITUATION Attribute. Definition: situationName is an attribute of the SITUATION table of the AGNAS database. It contains the name of a situation stored in the database. Data Type: String.

Attribute Name: speed. Type: FUSED_DEPICTION Attribute. Definition: speed is an attribute of the FUSED_DEPICTION table of the AGNAS database. This attribute contains the speed of moving targets. Data Type: Float.

Attribute Name: startTime. Type: MISSION Attribute. Definition: startTime is an attribute of the MISSION table of the AGNAS database. It contains the starting time for a scheduled UGV mission. Data Type: Date/Time.

Attribute Name: stepNum. Type: STEP Attribute. Definition: stepNurn is an attribute of the STEP table of the AGNAS database. It contains the sequence number of a step of a mission. Data Type: Integer. Restrictions: stepNurn>=0.

Attribute Name: stop. Type: SITUATION Attribute. Definition: stop is an attribute of the SITUATION table of the AGNAS database. It determines if the UGV, under a defined situation, should completely stop. Data Type: Boolean.

Attribute Name: stoppingDistance. Type: SITUATION Attribute. Definition: stoppingDistance is an attribute of the SITUATION table of the AGNAS database. It contains a value for the distance required for the UGV to come to a complete stop, assuming the UGV is traveling at the maximum speed allowed, defined in each situation. If an obstacle is located within the defined stopping distance, the UGV must redirect its course or stop immediately. Data Type: Float.

Attribute Name: targeted. Type: FUSED_DEPICTION Attribute. Definition: targetId is an attribute of FUSED_DEPICTION table of the AGNAS database. It contains the targetId of the object in the operational area. This attribute is a result of ATRS data fused with UGV data. Data Type: Integer.

Attribute Name: targetType. Type: FUSED_DEPICTION Attribute. Definition: targetType is an attribute of the FUSED_DEPICTION table of the AGNAS database. It represents the type of target being stored to the database. In general, 0=“Non UGV”: 1=“UGV.” Data Type: Integer.

Attribute Name: timestamp. Type: FUSED_DEPICTION Attribute. Definition: timeStamp is an attribute of the FUSED_DEPICTION table of the AGNAS database. It contains a time stamp of the fused data received from ATRS and UGV. It will be used during playback to display past events in chronological order. Data Type: Date/Time.

Attribute Name: travelSpeed. Type: SITUATION Attribute. Definition: travelSpeed is an attribute of the SITUATION table of the AGNAS database. It contains a value for the maximum allowable travel speed/velocity for an UGV operation within a given situation. Data Type: Float. Restrictions: travelSpeed>=0.

Attribute Name: userFirstName. Type: USER Attribute. Definition: userFirstName is an attribute of the USER table of the AGNAS database. It contains the first name of the RCC Operator. Data Type: String.

Attribute Name: userId. Type: USER Attribute. Definition: userId is an attribute of the USER table of the AGNAS database. It contains a unique identifier for each RCC Operator. Data Type: Integer.

Attribute Name: userLastName. Type: USER Attribute. Definition: userLastName is an attribute of the USER table of the AGNAS database. It contains the last name of the RCC Operator. Data Type: String.

Attribute Name: userName. Type: USER Attribute. Definition: userName is an attribute of the USER table of the AGNAS database. It contains the username of the RCC Operator. It is used during the login process for proper RCC Operator validation. Data Type: String

Attribute Name: userPassword. Type: USER Attribute. Definition: userPassword is an attribute of the USER table of the AGNAS database. It contains the password of the RCC, Operator. It is used during the login process for proper RCC Operator validation. Data Type: String.

Attribute Name: waitTime. Type: STEP Attribute. Definition: waitTime is an attribute of the STEP table of the AGNAS database. It stores the number of minutes an UGV should wait at a particular destination waypoint of the mission. Data Type: Integer.

Attribute Name: width. Type: FUSED_DEPICTION Attribute. Definition: width is an attribute of the FUSED_DEPICTION table of the AGNAS database. It contains the width of the target either as sent by the UGV or as received by the ATRS. Data Type: Float.

Attribute Name: xCoord. Type: VIRTUAL_MAP_COORD Attribute. Definition: xCoord is an attribute of the VIRTUAL_MAP_COORD table of the AGNAS database. It contains the x-axis coordinate located on a Virtual Map stored in the database. Data Type: Integer.

Attribute Name: yCoord. Type: VIRTUAL_MAP_COORD Attribute. Definition: yCoord is an attribute of the VIRTUAL_MAP_COORD table of the AGNAS database. It contains the y-axis coordinate located on a Virtual Map stored in the database. Data Type: Integer.

RCC Graphic User Interface (GUI). The RCC GUI has the following capabilities: 1) to provide a display which is the most prominent feature of the RCC GUI, occupying a large portion of the window to provide maximum visibility of the operating area; 2) to provide a display that enhances situational awareness by displaying a clear and accurate depiction of the events occurring in the operational area in real-time; 3) to configure Virtual Maps; 4) to dynamically define areas or redefine the Virtual Map (e.g., the system will provide the ability to dynamically expand or contract the operational area in the event of construction); 5) to dynamically expand or contract the radar coverage operational area that is being monitored; 6) to allow the user to not only observe the UGV's movements, but also to remotely operate and re-task the UGV when the need arises; 7) to contain an interface to create Mission Plans, which are stored to the AGNAS database and are executable at a later time by the RCC Operator; and 8) to play back the stored, fused data, allowing the user to review operations as they occurred during a previous time frame.

The RCC GUI has a primary window that consists of multiple layers. The bottom layer is a background image that is a scaled map of the operational area. Superimposed over the background image is a graphical representation of the Depiction data structure received from the Data Fusion component of the CCM. This informs the RCC Operator of the UGV's location, as well as the location of any other targets in the operational area.

A prerequisite to executing primary AGNAS functionality is that at least one operational area configuration must be defined. The RCC Operator creates an operational area configuration by filling in permissible values into cells on a grid. The result of this configuring is a Virtual Map of the operational area that indicates obstacles that are permanent obstructions (i.e. buildings, hangars, radar stations, terrain, etc). The RCC operator is able to adjust a Virtual Map from the RCC GUI. In the example, zeros represent out of bounds sectors that the UGV is not permitted to enter under normal operating conditions. A score of one represents the ideal path. Anything greater than one indicates that the path is less than ideal, but it is traversable using caution. The higher the number, the less ideal the path is.

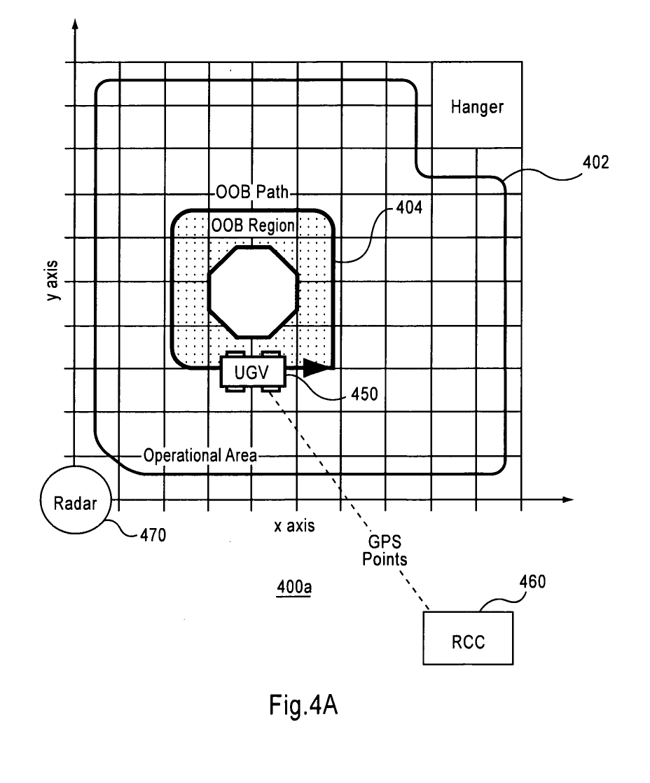

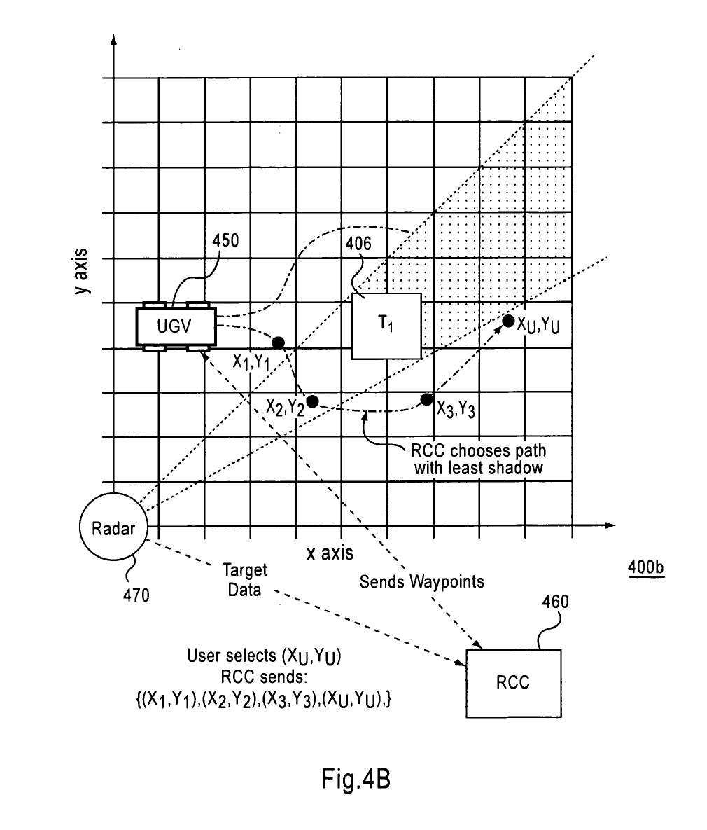

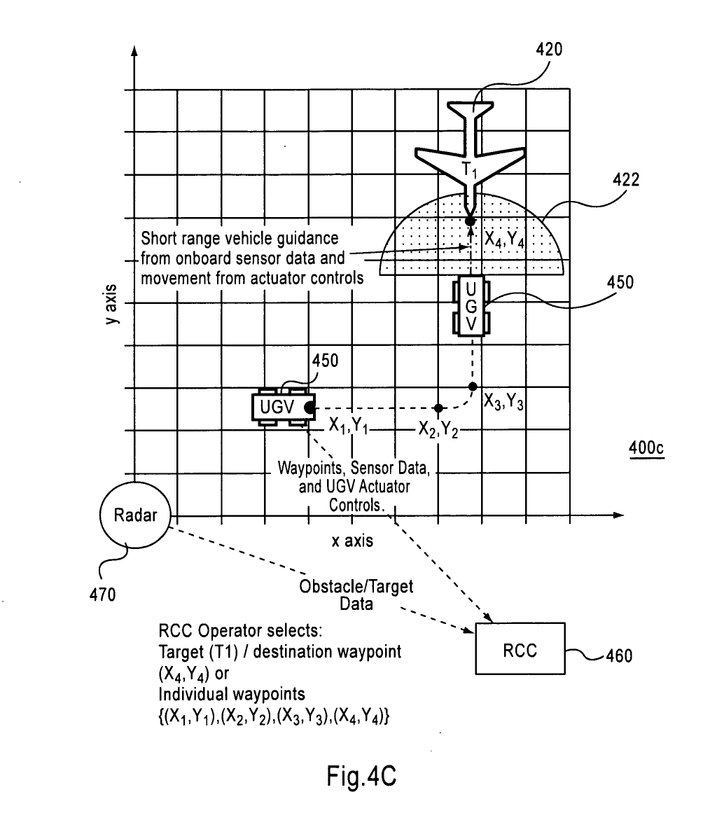

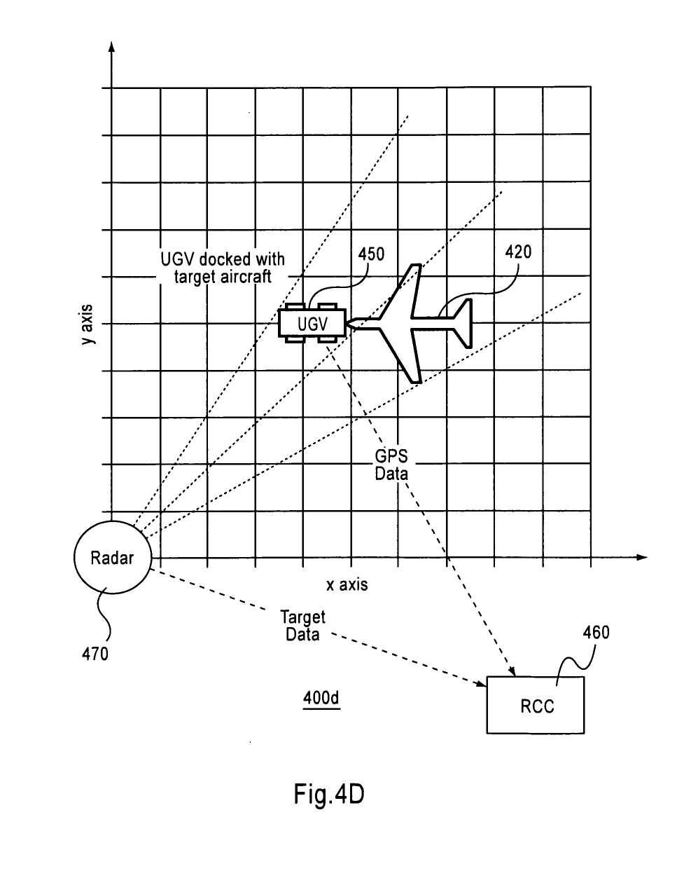

FIG. 4A is a display diagram 400a illustrating an example of defining an airport operational area comprising one or more operational area paths. As part of an initialization of an operational area, a number of paths 402, 404 may variously be defined. The UGV 450 may be operated in conjunction with defining the paths and communicate feedback to the RCC 460. Specifically, for example, the UGV 410 may be manually operated along a desired path to define a perimeter, out of bounds, or other boundary in defining the operational area. Alternatively, predetermined paths may be mapped out, with the UGV 410 being operated manually, automatically, or semi-autonomously to confirm the paths. Electronic tracking such as via radar 470 is also preferably provided in conjunction with path definition. A first indicated path 402 may define the perimeter of a given operational area. Such an operational area may exclude external objects or improper locations. Another indicated operational path 404 may define by a boundary dividing the operational area from an out of bounds area. Preferably, but not necessarily, the defined operational area will be a closed operational area, such that the UGV is confined to operation within predetermined boundaries.

It should be noted that numerous operational areas may be created, with various UGVs potentially corresponding to respective operational areas.

The ability to define and configure the ATRS functionality of AGNAS is part of the functionality of the RCC GUI, which also contains the controls necessary to direct the UGV remotely, with the RCC Operator having overriding control of the UGV. Controls consist of commands to start up, shut down, navigate, and request a status report. The status report informs the RCC Operator of pertinent information obtained through JAUS messages from the UGV. A safety feature of the RCC GUI is an emergency stop button that allows the RCC Operator to stop the UGV in the event of an emergency or system failure.

Through the Mission Planner interface of the RCC GUI, the RCC Operator is able to plan a mission. The RCC Operator selects an UGV for the mission. The mission must contain at least one destination point. However, it can contain multiple destination points to create a particular path. The RCC Operator selects destination points by clicking on a map of the operational area, resulting in the construction of a Mission Plan data structure. The Mission Planner validates that each point is legal. After the mission is defined, the Mission Planner Data Structure Converter converts the Mission Planner data structure into data that is stored in the database with a unique ID. To execute a mission, the RCC Operator selects a mission name from the RCC GUI which sends the missionId to the Behavior subcomponent to execute the mission.

FIG. 4B is a display diagram 400b illustrating an example of defining an example of flexible navigation according to another aspect. The path determined for a UGV may be generated in conjunction with completing a mission. In this example, an obstacle 406 may be outside the UGV sensor range and it may be desirable to navigate the UGV 450 according to a path that provides maximum coverage by other tracking systems (e.g., radar 470). For example, a user may input destination coordinates (X_{U}, Y_{U}) that in a direct path would cause the UGV 450 to collide with the obstacle 406, and in another path would travel substantially through a radar shadow area. In these circumstances, the RCC 460 may send waypoints that avoid the obstacle and maximize supplemental positional coverage of the UGV 450, for example, the series (X₁, Y₁), (X₂, Y₂), (X₃, Y₃), (X_{U}, Y_{U}) as indicated in the figure.

Another significant mission is docking with an aircraft pursuant to a towing operation, as previously described. FIG. 4C is a display diagram 400c illustrating an example of aircraft 420 docking. In such an operation, the RCC 460 may send the UGV 450 waypoints so that the UGV 450 approaches the aircraft 420 and detects the target, which is confirmed to the RCC 460. When the UGV 450 is within a specified range 422 and has confirmed the target, the RCC 460 instructs the UGV 450 to disable forward-looking obstacle detection and enable precision steering toward the target (aircraft 420). Onboard stereo vision sensors may be used to enable precision steering of the UGV 450 for the final docking maneuvers. The UGV 450 engages the aircraft 420, exercises specified docking controls, and sends a confirmation message back to the RCC 460 that the target is docked and locked into transport position. The UGV 450 then holds in a ready state awaiting receipt of the next mission path. As noted, these paths may be throughout the operational area, and may comprise runway and taxiway positions as desired.

According to still another aspect, radar and GPS are fused to better indicate the position of the UGV. FIG. 4D is a display diagram 400d illustrating such a data fusion operational scenario. Both the GPS data and the radar target data are transmitted to the RCC 460. If this data is not fused, then the GPS coordinates could vary slightly, and radar data could misinterpret a target or portion thereof as the UGV, which could result in multiple possible (or erroneous) coordinates for a given UGV. The RCC determines which ATRS target is the UGV with reconciliation based upon the GPS data and discretely and accurately displays target image(s) accordingly. This scenario is helpful to establish an ATRS target profile of the UGV when it is docked with a designated target (e.g., aircraft 420).

The RCC GUI has a window used to play back selected time periods stored in the database. A copy of each Depiction data structure generated by the Data Fusion component is stored in the database. When the RCC Operator requests to view a particular time period captured by the AGNAS system, the database is queried for Depictions within the requesting range. The data extracted is converted into Depiction data structures by the Depiction Data Structure Converter and then sent to the RCC GUI. The Playback window displays the Depiction data structures in the same manner as they would be displayed in real-time

The GUI contains an administrative section that facilitates the adding, editing, and deactivating of rules in the database. The user management of AGNAS operators is part of the administrative section. It enables operator logins to be created, updated, and deleted from the system, and it also enables the management of passwords associated with the operator logins.

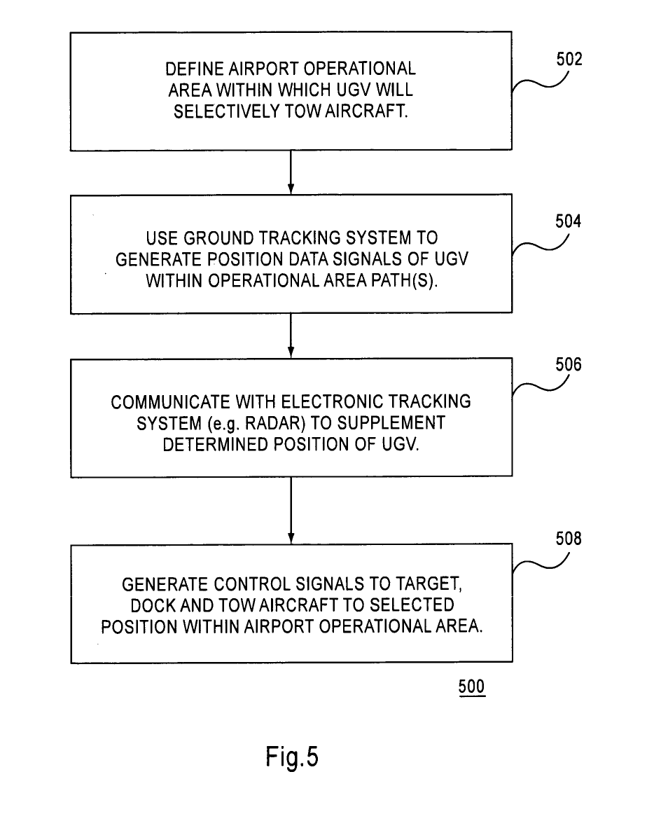

FIG. 5 is a flow diagram illustrating a method 500 for transporting aircraft within an airport operational area. The method is preferably a computer-implemented process engaged according to the AGNAS system functionality as described in further detail above.

The method includes defining 502 an airport operational area within which an unmanned ground vehicle is configured to selectively tow aircraft. The airport operational area may be variously defined as described above, such as by navigating the UGV to define perimeter and boundary paths, or it may be input to the system from previously defined parameters.

Then, a ground tracking system may be used 504 to generate position data signals to determine the position of the UGV relative to positions in at least one operational area path contained in the airport operational area. As noted above, these operational area paths may be previously defined in conjunction with defining the airport operational area, or may be mission paths that are generated on-the-fly in conjunction with a current mission (e.g., targeting, docking and towing an aircraft). The ground tracking system may be based upon sensors and feedback provided by the UGV in conjunction with its movement.

An electronic tracking system, such as radar, is also used to assist in UGV navigation. Communicating 506 with an electronic tracking system provides signals that supplement the determined position of the UGV relative to positions in the operational area paths.

The UGV is instructed to ultimately target and then dock with an aircraft as described above, and then further position control data signals are generated 508 to selectively guide the UGV and its towed aircraft to a selected position within the airport operational area. As described, this may be a taxiway, runway, or any preferred location within the airport operational area as previously defined.

Although the present invention has been described in considerable detail with reference to certain embodiments thereof, the invention may be variously embodied without departing from the spirit or scope of the invention. Therefore, the following claims should not be limited to the description of the embodiments contained herein in any way.

What is claimed is:

1. A computer-implemented method for transporting aircraft within an airport operational area, the method comprising:
defining an airport operational area within which an unmanned ground vehicle is configured to selectively tow aircraft;
using a ground tracking system to generate position data signals to determine the position of the unmanned ground vehicle position relative to positions in at least one operational area path contained in the airport operational area;
communicating with an electronic tracking system to generate signals that supplement the determined position of the unmanned ground vehicle relative to positions in the operational area paths; and
generating position control data signals for the unmanned ground vehicle to selectively guide the unmanned ground vehicle and an aircraft engaged and towed by the unmanned ground vehicle to a selected position within the airport operational area.

2. The method of claim 1, wherein defining the airport operational area further comprises receiving communications from the unmanned ground vehicle that indicate positions of the unmanned ground vehicle as it travels along a designated operational area path contained in the airport operational area.

3. The method of claim 1, further comprising:
receiving GPS position data signals from the unmanned ground vehicle to further supplement the determined position of the unmanned ground vehicle relative to positions in the operational area paths.

4. The method of claim 3, wherein the electronic tracking system is a radar based system.

5. The method of claim 1, wherein engaging and towing the aircraft relocates the aircraft from a starting position to a runway or taxi-way position within the airport operational area.

6. The method of claim 1, wherein the an airport operational area is a closed operational area.

7. The method of claim 1, further comprising:
transmitting an interrupt data signal to selectively stop the unmanned ground vehicle upon receipt of said interrupt data signal.

8. The method process of claim 1, further comprising:
shutting down the engines of an aircraft to be moved by an unmanned vehicle from a desired first position on the operational area to another position on the operational area and then if desired, selectively providing power to start up the engines of the aircraft for take off.

9. A system for transporting aircraft within an airport operational area, the system comprising:
means for defining an airport operational area within which an unmanned ground vehicle is configured to selectively tow aircraft;
means for using a ground tracking system to generate position data signals to determine the position of the unmanned ground vehicle position relative to positions in at least one operational area path contained in the airport operational area;
means for communicating with an electronic tracking system to generate signals that supplement the determined position of the unmanned ground vehicle relative to positions in the operational area paths; and
means for generating position control data signals for the unmanned ground vehicle to selectively guide the unmanned ground vehicle and an aircraft engaged and towed by the unmanned ground vehicle to a selected position within the airport operational area.

10. The system of claim 9, wherein defining the airport operational area further comprises receiving communications from the unmanned ground vehicle that indicate positions of the unmanned ground vehicle as it travels along a designated operational area path contained in the airport operational area.

11. The system of claim 9, further comprising:
means for receiving GPS position data signals from the unmanned ground vehicle to further supplement the determined position of the unmanned ground vehicle relative to positions in the operational area paths.

12. The system of claim 11; wherein the electronic tracking system is a radar based system.

13. An apparatus for transporting aircraft within an airport operational area, the apparatus comprising:
a control module, which defines an airport operational area within which an unmanned ground vehicle is configured to selectively tow aircraft, communicates with a ground tracking system to generate position data signals to determine the position of the unmanned ground vehicle position relative to positions in at least one operational area path contained in the airport operational area, communicates with an electronic tracking system to generate signals that supplement the determined position of the unmanned ground vehicle relative to positions in the operational area paths, and generates position control data signals for the unmanned ground vehicle; and
a transmitter, which transmits the position control data signals to selectively guide the unmanned ground vehicle and an aircraft engaged and towed by the unmanned ground vehicle to a selected position within the airport operational area.

14. The apparatus of claim 13, wherein defining the airport operational area further comprises receiving communications from the unmanned ground vehicle that indicate positions of the unmanned ground vehicle as it travels along a designated operational area path contained in the airport operational area.

15. The apparatus of claim 13, further comprising:
means for receiving GPS position data signals from the unmanned ground vehicle to further supplement the determined position of the unmanned ground vehicle relative to positions in the operational area paths.

16. The apparatus of claim 15, wherein the electronic tracking system is a radar based system.

17. A computer implemented method for transporting aircraft within an airport operational area, the method comprising:
communicating with a control module to define an airport operational area within which an unmanned ground vehicle is configured to selectively tow aircraft;
communicating with the control module to use a ground tracking system supplemented by an electronic tracking system to receive position data signals to determine the position of the unmanned ground vehicle position relative to positions in at least one operational area path contained in the airport operational area;
receiving position control data signals for the unmanned ground vehicle to selectively guide the unmanned ground vehicle and an aircraft engaged and towed by the unmanned ground vehicle to a selected position within the airport operational area.

18. The method of claim 17, wherein defining the airport operational area further comprises transmitting communications from the unmanned ground vehicle that indicate positions of the unmanned ground vehicle as it travels along a designated operational area path contained in the airport operational area.

19. The method of claim 18, further comprising:
transmitting GPS position data signals from the unmanned ground vehicle to further supplement the determined position of the unmanned ground vehicle relative to positions in the operational area paths.

20. The method of claim 17, wherein the electronic tracking system is a radar based system.

21. A unmanned ground vehicle apparatus for transporting aircraft within an airport operational area, the apparatus comprising:
a transmitter, which communicates with a control module to define an airport operational area within which an unmanned ground vehicle is configured to selectively tow aircraft, and which communicates with the control module to use a ground tracking system supplemented by an electronic tracking system to receive position data signals to determine the position of the unmanned ground vehicle position relative to positions in at least one operational area path contained in the airport operational area;
a latch, for docking with an aircraft to engage the aircraft; and
a receiver, for receiving position control data signals for the unmanned ground vehicle to selectively guide the unmanned ground vehicle and the aircraft engaged and towed by the unmanned ground vehicle to a selected position within the airport operational area.

22. The apparatus of claim 21, wherein defining the airport operational area further comprises generating communications from the unmanned ground vehicle that indicate positions of the unmanned ground vehicle as it travels along a designated operational area path contained in the airport operational area.

23. The apparatus of claim 21, wherein the transmitter transmits GPS position data signals from the unmanned ground vehicle to further supplement the determined position of the unmanned ground vehicle relative to positions in the operational area paths.

24. The apparatus of claim 23, wherein the electronic tracking system is a radar-based system.
